(19) United States
(12) Patent Application Publication
(10) Pub. No.: US 2024/0157520 A1
(43) Pub. Date: May 16, 2024

(54) Torque Multiplier

(71) Applicant: Adam Ellison, San Francisco, CA (US)

(72) Inventor: Adam Ellison, San Francisco, CA (US)

(21) Appl. No.: 18/510,640

(22) Filed: Nov. 15, 2023

Related U.S. Application Data
(60) Provisional application No. 63/425,781, filed on Nov. 16, 2022.

(51) Int. Cl. B25B 17/02

(52) U.S. Cl. CPC B25B 17/02; F16H 25/14

(57) ABSTRACT

Numerous examples of a torque multiplier and associated methods are disclosed. In one example, a torque multiplier comprises a first shaft for providing a first torque; a second shaft for providing a second torque; and a gear structure coupled to the first shaft and the second shaft to multiply the first torque to generate the second torque, the gear structure comprising a lobe ring, a plurality of roll rings in contact with the lobe ring, a pin structure comprising a plurality of pins, each of the pins located inside one of the roll rings; and a bearing in contact with the plurality of roll rings.

### PRIORITY CLAIM

This application claims priority to U.S. Provisional Patent Application No. 63/425,781, filed on Nov. 16, 2022, and titled, “Mechanical Torque Multiplier with Improved Efficiency Utilizing Hollow Rolling Elements,” which is incorporated by reference herein.

### FIELD OF THE INVENTION

Numerous examples of a novel torque multiplier and its components are disclosed.

### BACKGROUND OF THE INVENTION

In the field of mechanical power transmission, it is common to use rotating shafts, motors, or levers to perform useful work or energy conversion. Often the speed or torque required by the load cannot be directly generated by the rotary power source. In these cases, it is necessary to convert low torque, high speed rotation into high torque, low speed rotation or to covert high torque, low speed rotation into low torque, high speed rotation. A device for performing this function is sometimes referred to as a torque multiplier, a gearbox, a speed reducer, or a mechanical transmission system or similar terms. As used herein, this device will be referred to as a torque multiplier.

A torque multiplier allows the motor or generator to operate at a given multiple of the input torque. This allows a designer to optimize the speed and torque characteristics required in the application of rotating machines. In general, many applications have a need for high efficiency rotary power conversion with a large speed ratio, compact form factor, hollow bore, high torque density or low mass.

In the category of large ratio torque multipliers, prior art torque multipliers have been introduced, but each has a significant design trade-off intended to meet a market need. These prior art solutions are summarized in Table No. 1.

TABLE NO. 1
SUMMARY OF PRIOR ART TORQUE MULTIPLIERS

| | Attributes and Performance | | | | |
|---|---|---|---|---|---|
| | Torque | Energy | Torque | | Shock Load |
| Design | Density | Efficiency | Linearity | Lash | Capacity |
| Strain wave | High | Low | Low | Low | Med |
| gearing | | | | | |
| Traditional | High | Med | Med | Low-med | High |
| Cycloid | | | | | |
| Planetary | Med | High | High | Med | Med |
| gearing | | | | | |
| Series spur | Low | High | High | Med-high | Low |
| gear | | | | | |
| Disclosed | High | High | High | Low | High |
| design | | | | | |

A huge amount of energy is wasted globally by inefficient power transmission devices, especially in the high ratio category. Significantly improving the efficiency of torque multiplication will impact global emissions and allow new high performance motion devices to be created. For example, one prior art design is known in the art as a “Cycloidal Reducer.” The “Cycloidal Reducer” suffers from several well-known deficiencies. These deficiencies include expensive manufacturing to reduce lash, limited hollow bore clearance, noise vibration and harshness, and low energy efficiency due to sliding interfaces. The latter is typically improved by adding bushes or bearings, increasing cost and complexity.

A new torque multiplier design is needed.

### SUMMARY OF THE INVENTION

The disclosed designs offer a unique combination of properties, specifically the combination of high torque density, high efficiency, and high linearity, with a large hollow bore. The disclosed torque multipliers have some similarities to existing cycloidal and other small tooth difference epicyclic devices but have several substantial differences and improvements. For example, the typical cycloid disc element is replaced by a plurality of roll rings, and the inside diameter of each roll ring against the torque pins, while the outside diameter of each roll ring is in contact with, and rolls against, both lobes and an eccentric bearing. This innovation reduces inertia, friction and distributes the load more evenly between lobes, improving load capacity and torque linearity.

The disclosed designs combine the torque generating lobe interface with the torque transfer stage via a plurality of roll rings to increase the torque density and reduce the friction for a given part count.

### BRIEF DESCRIPTION OF THE DRAWINGS

FIG. 1 depicts a plan view of an assembled torque multiplier.

FIG. 2 depicts an isometric view of the assembled torque multiplier.

FIG. 3 depicts a cross-section of a torque multiplier comprising a first embodiment of a gear structure.

FIG. 4 depicts an axial view of the first embodiment of a gear structure.

FIG. 5 depicts relative motion of certain components in the first embodiment of a gear structure.

FIG. 6 is an enlarged view of the first embodiment of a gear structure and shows the lobes of the lobe ring.

FIG. 7 depicts an enlarged view of the first embodiment of a gear structure and shows reaction force vectors between various components.

FIG. 8 depicts an axial view of a second embodiment of a gear structure.

FIG. 9 depicts an axial view of a third embodiment of a gear structure.

FIG. 10 depicts relative motion of certain components in an axial view of a fourth embodiment of a gear structure.

FIG. 11 depicts an axial view of a fifth embodiment of a gear structure.

FIG. 12 depicts a single-piece retainer.

FIG. 13 depicts an isometric view of a sixth embodiment of a gear structure comprising the single-piece retainer.

FIG. 14 depicts an isometric view of a double-piece retainer.

FIG. 15 depicts an axial view of a seventh embodiment of a gear structure comprising the double-piece retainer.

FIG. 16 depicts another perspective of the seventh embodiment of a gear structure.

FIG. 17 depicts a cross-section of a torque multiplier including two axially-stacked gear structures.

FIG. 18 depicts an axial view of a torque multiplier including two axially-stacked gear structures.

FIG. 19 depicts an exploded view of the two axially-stacked gear structures.

FIG. 20 depicts a cross section view of a seventh embodiment of a gear structure.

FIG. 21 depicts an axial view of a torque multiplier with an eighth embodiment of a gear structure.

FIG. 22 depicts a method of operating a torque multiplier.

FIG. 23 depicts a system utilize a torque multiplier.

### DETAILED DESCRIPTION OF THE INVENTION

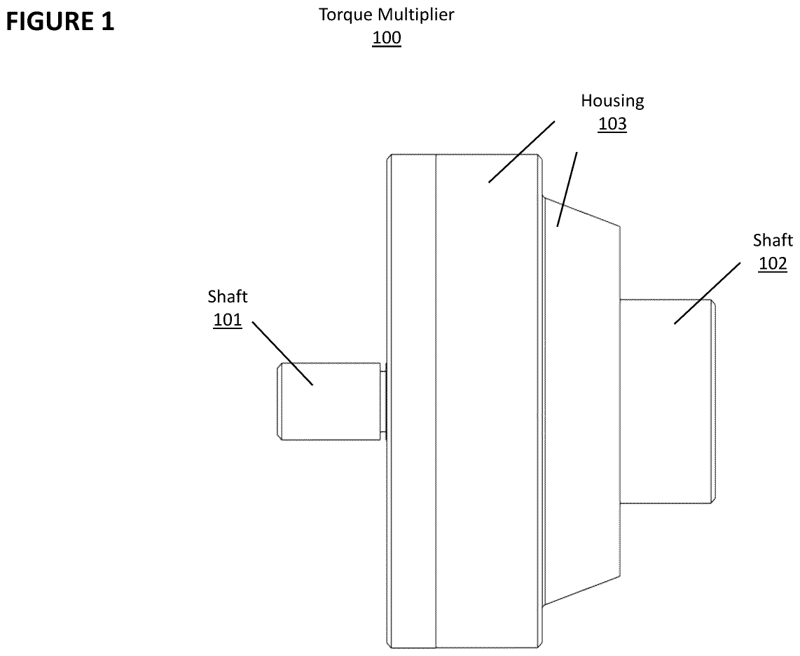

FIG. 1 depicts a plan view of a torque multiplier 100 in assembled form. Torque multiplier 100 comprises shaft 101, shaft 102, and housing 103. In a first mode, shaft 101 receives the input torque and shaft 102 delivers the output torque, where the output torque is greater than the input torque by a factor N, where the output torque=the input torque*N. In a second mode, shaft 102 receives the input torque and shaft 101 delivers the output torque, where the output torque is smaller than the input torque by a factor of N, where the output torque=the input torque*(1/N). Housing 103 encloses other components (not shown, but described below) that provide the torque multiplication between shafts 101 and 102.

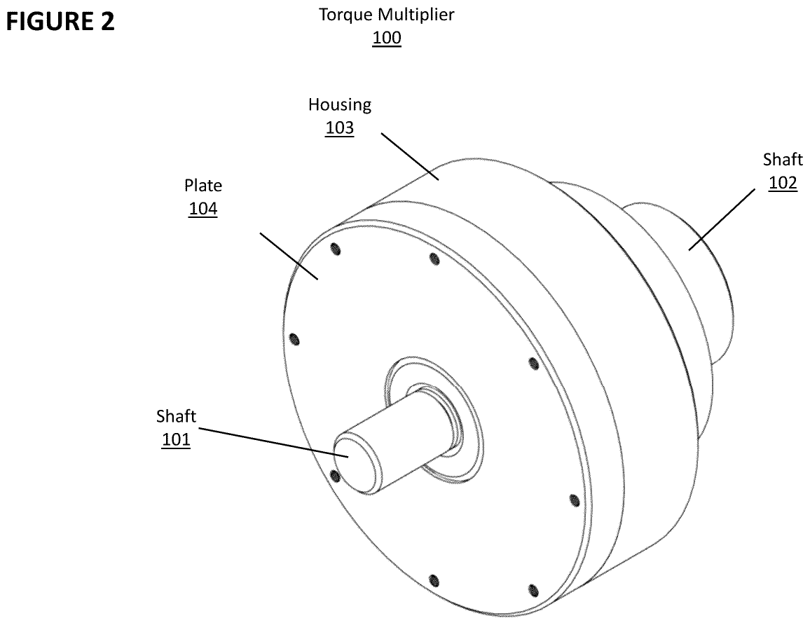

FIG. 2 depicts an isometric view of torque multiplier 100 in assembled form. Shafts 101 and 102 and housing 103 are again displayed. Torque multiplier 100 further comprises plate 104, which is coupled to housing 103.

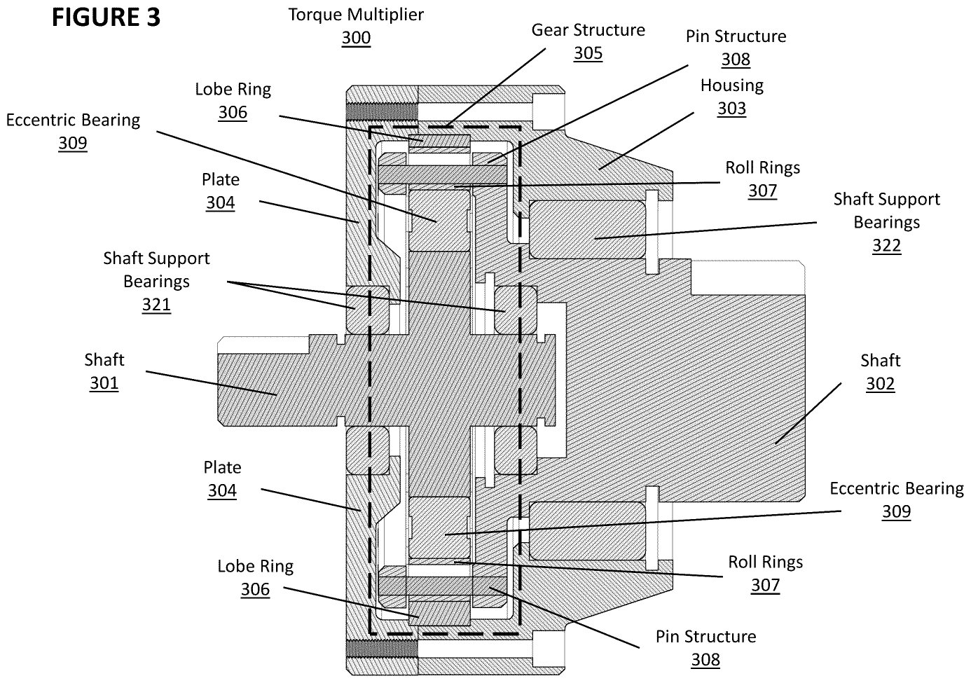

FIG. 3 depicts a cross section of torque multiplier 300 showing shafts and bearing support of an assembled device with an eccentric bearing race. Torque multiplier 300 is an example of torque multiplier 100 using the gear structure depicted in FIG. 3. Torque multiplier 300 comprises shafts 301 and 302 (which are examples of shafts 101 and 102 in FIGS. 1-2), housing 303 (which is an example of housing 103 in FIGS. 1-2), and plate 304 (which is an example of plate 104 in FIG. 2). Torque multiplier 300 further comprises gear structure 305, which is a first embodiment of a gear structure disclosed herein, and which provides the torque multiplication between shafts 301 and 302, and shaft support bearings 321 and 322.

Gear structure 305 comprises lobe ring 306, roll rings 307, pin structure 308, and eccentric bearing 309. Gear structure 305 is a circular or roughly circular device that in FIG. 3 is viewed from its side when it is standing up. Thus, plate 304, lobe ring 306, pin structure 308, and eccentric bearing 309 each appears as two items on the top and bottom of the diagram of FIG. 3 but each is actually a single item that is shown here in cross section form (much like a cross section of a donut would appear to be a top circle and a bottom circle). Similarly, roll rings 307 and pin structure 308 are a plurality of roll rings and pins, with only two of them shown here in the cross-section.

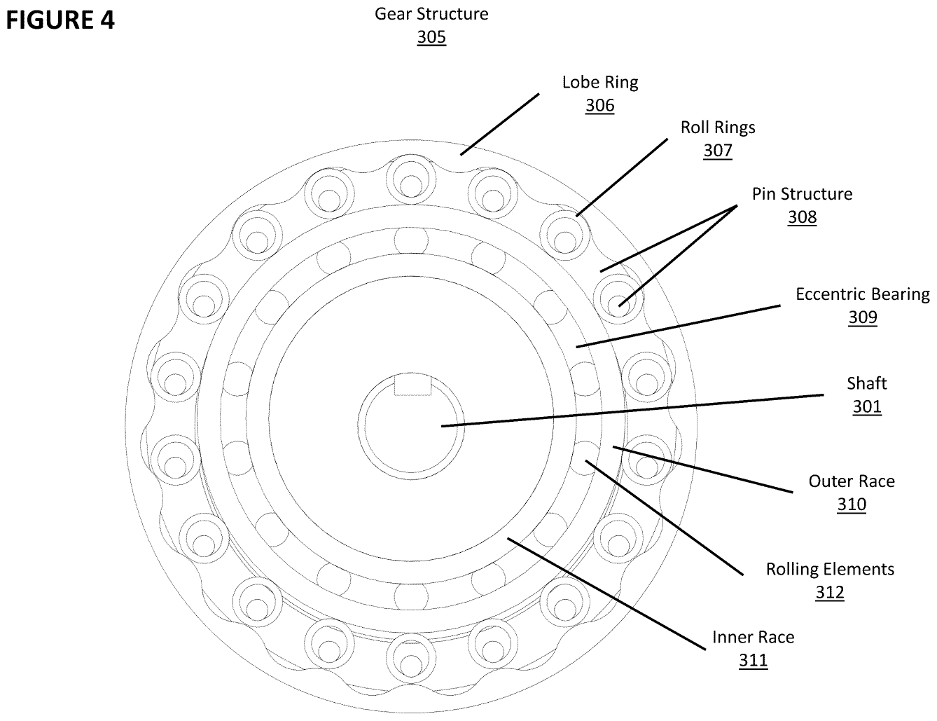

FIG. 4 depicts an axial view of gear structure 305 and its key components. Lobe ring 306, roll rings 307, pin structure 308, and eccentric bearing 309 are again displayed. Shaft 301 also is displayed, which interacts with gear structure 305. Shaft 301 is an eccentric crankshaft, and it can be seen that eccentric bearing 309 is not concentric around the axis of shaft 301. A balancing counterweight (not shown) optionally can be included to balance the asymmetrical weight distribution of the crankshaft. Eccentric bearing 309 comprises outer race 310, inner race 311, and rolling elements 312 between outer race 310 and inner race 311. As can be seen in the example of FIG. 4, lobe ring 306 is a ring with an outer circumference of a circular or roughly circular shape and an inner circumference comprising a Roulette shape. In this example, the shape is a modified hypotrochoidal shape, but other shapes can be used instead. Roll rings 307 are a series of rings positioned within, and engaging the inner circumference of lobe ring 306, and positioned outside of, and engaging with the outer circumference of outer race 310. The inner circumference of each roll ring 307 engages with a pin from pin structure 308. Pin structure 308 comprises a plate with a series of pins, where each pin is placed within a roll ring 307. Pins are nominally circular, but the shape may be modified to increase clearance or improve performance. Eccentric bearing 309 is eccentric because it rotates in conjunction with shaft 301, which is an eccentric crankshaft. Outer race 310 engages with roll rings 307.

In one example, pin structure 308 rotates and lobe ring 306 is fixed to the housing (not shown) and does not rotate, and pin structure 308 is fixed to shaft 302 (not shown) such that when pin structure 308 rotates around the axis of gear structure 305, it turns shaft 302 around the axis. In another example, lobe ring 306 rotates and pin structure 308 is fixed to the housing (not shown) and does not rotate, and lobe ring 306 is fixed to shaft 302 (not shown) such that when lobe ring 306 rotates around the axis of gear structure 305, it turns shaft 302 around the axis.

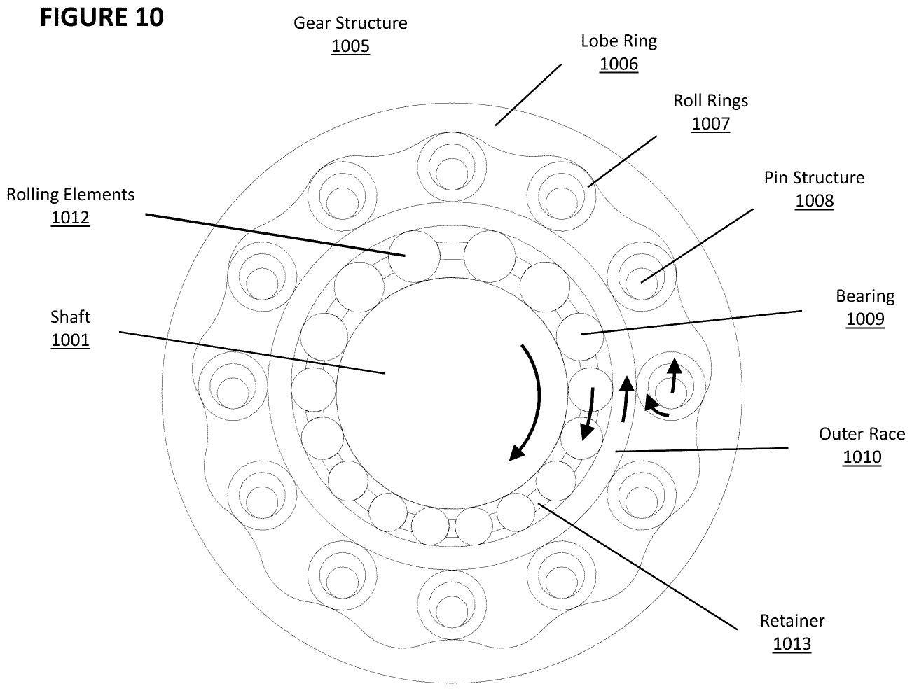

Optionally, gear structure 305 can comprise a retainer (not shown, such as retainer 1013 in FIG. 10) for retaining rolling elements 312 in their relative position as to one another, to prevent jamming. Optionally, gear structure 305 can comprise a retainer (not shown, such as retainers 1201 and 1401) for retaining roll rings 307 in their relative position as to one another.

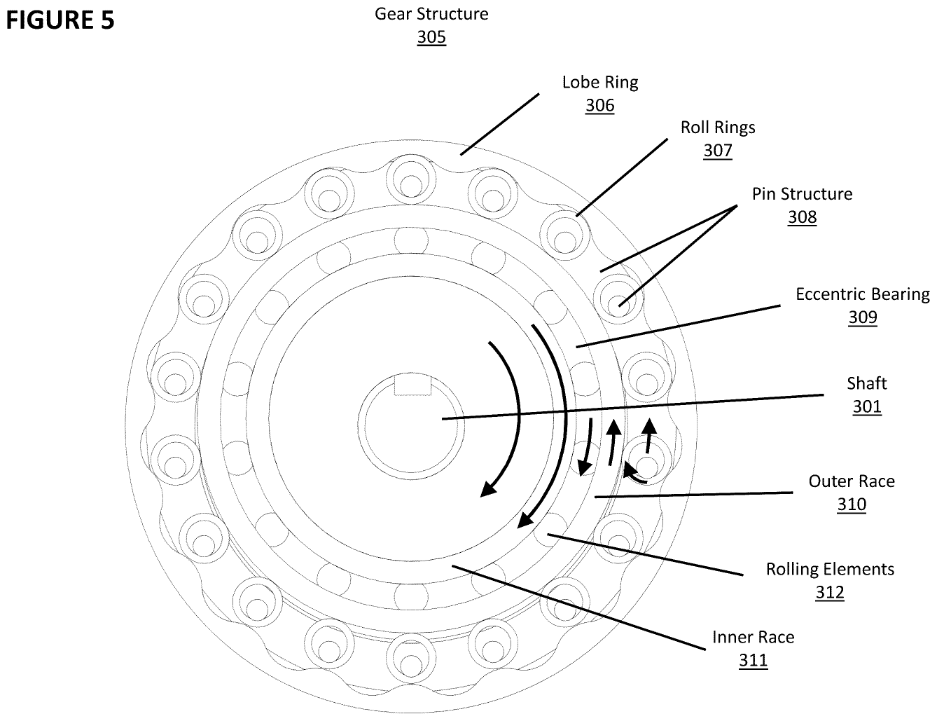

FIG. 5 depicts the relative movement of certain components in gear structure 305, where lobe ring 306 is fixed to a housing and pin structure 308 is fixed to shaft 302. Shaft 301 is attached to inner race 311. Shaft 301 will turn in response to an input torque, which in this example is in the clockwise direction, which will cause inner race 311 to also turn in the clockwise direction. Rolling elements 312 will as whole rotate clockwise but also will individually rotate counter-clockwise, enabling outer race 310 to rotate counter-clockwise freely as urged by contact with the roll rings 307. The movement of the eccentric axis of bearing 309 about the concentric axis of shaft 301 will cause roll rings 307 to individually roll clockwise against the fixed lobe ring 306, while also rotating clockwise positionally about a pin 308. The roll ring assembly as whole rotates together with pin structure 308 (which in this example is fixed to shaft 302 (not shown), which thereby prevents roll rings from traversing relative to shaft 302, while allowing each roll ring to spin in the counter-clockwise or clockwise directions, rolling about a pin 308), which will cause pin structure 308 and shaft 302 to rotate counter-clockwise.

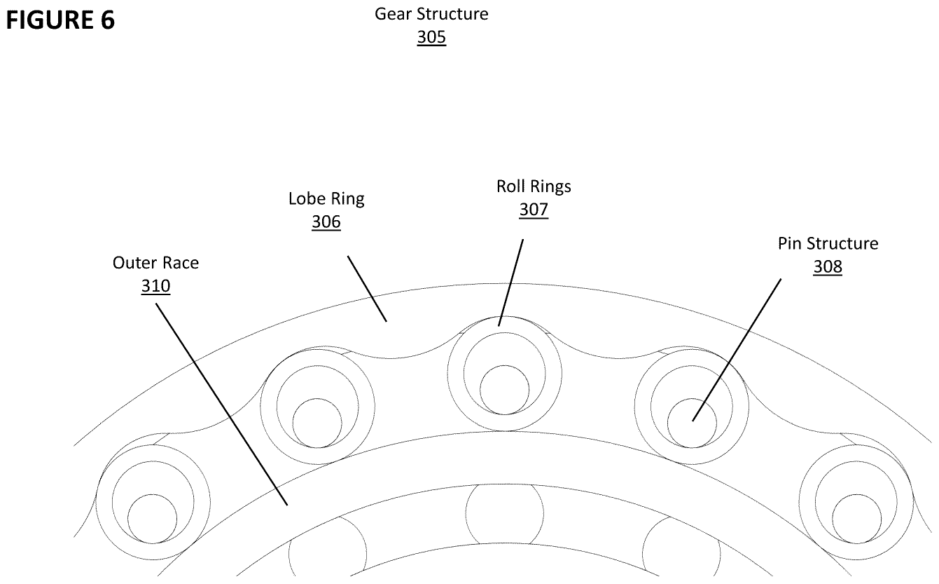

FIG. 6 is an enlarged view of gear structure 305 and shows the interaction of lobe ring 306, roll rings 307, pin structure 308, and outer race 310 and the modified hypotrochoidal lobes of lobe ring 306. In this example, the inner circumference of lobe ring 306 comprises modified hypotrochoidal lobes, but other shapes can be used.

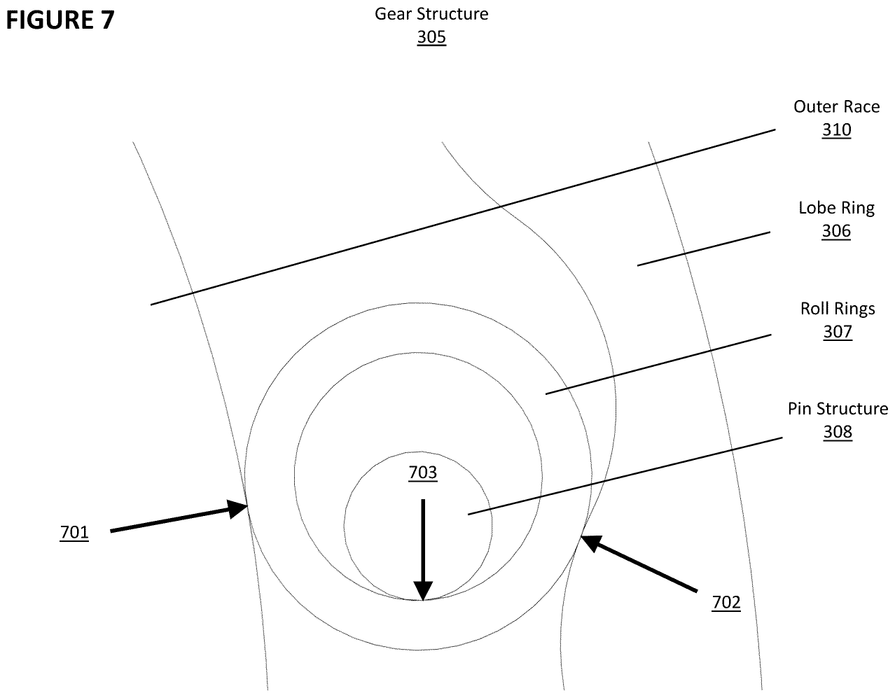

FIG. 7 is a further enlarged view of gear structure 305 and shows the interaction of lobe ring 306, a single roll ring 307, pin structure 308, and outer race 310 and shows reaction force vectors as experienced by a roll ring 307 while transmitting torque as shown in FIG. 5 and described prior. Reaction force vector 701 depicts the reaction force by outer race 310 upon roll ring 307, reaction force vector 702 depicts the reaction force by lobe ring 306 upon roll ring 307, and reaction force vector 703 depicts the reaction force by pin structure 308 upon roll ring 307. The tangential component of reaction force 703 is what reacts the load torque on shaft 302 and pin structure 308 in the prior example.

Additional embodiments of gear structures that operate according to similar principles already described for gear structure 305 will now be described.

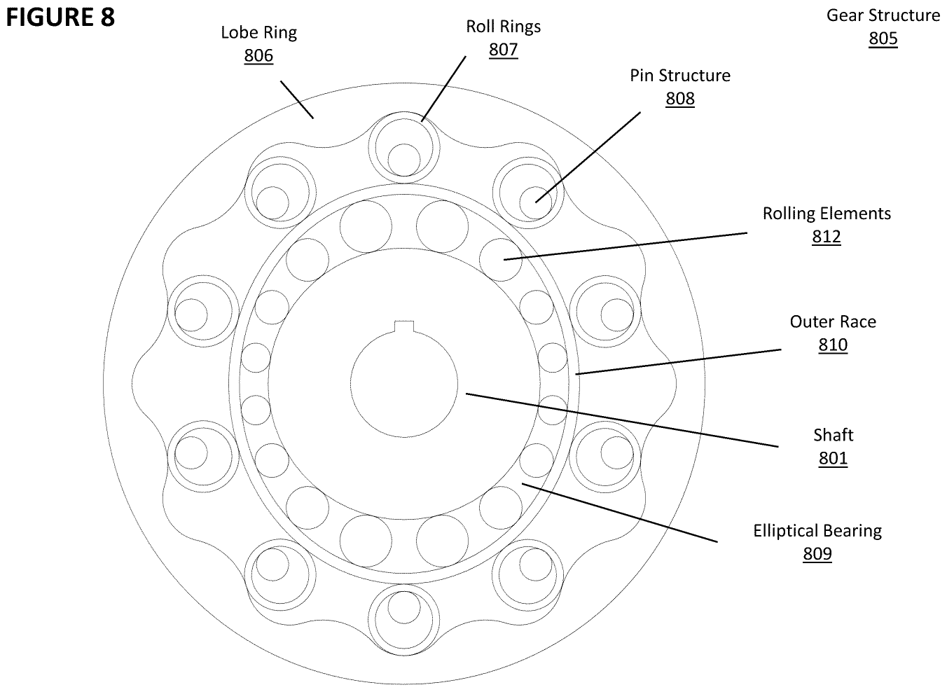

FIG. 8 depicts gear structure 805, which is a second embodiment of a gear structure and which can be used in place of gear structure 305 in torque multiplier 300 in FIG. 3. FIG. 8 depicts an embodiment with a combined elliptical bearing and traction planetary first multiplication stage providing a further torque multiplication factor of approximately 2. Lobe rings 807 are driven in this figure by a flexible elliptical bearing outer race 810. Gear structure 805 comprises lobe ring 806, roll rings 807, pin structure 808, and elliptical bearing 809. Elliptical bearing 809 comprises outer race 810 and rolling elements 812 rolling an inner race integrated into shaft 801. In this example, shaft 801 is concentric and not eccentric, and outer race 810 is a flexible elliptical race, such that its radius will move in relation to the axis of shaft 801. Rolling elements 812 do not all have the same diameter. That is, rolling elements 812 comprise rolling elements of two or more diameters, optionally positioned by a retainer (not shown). Rolling elements 812 are sized and positioned to flex the outer race 810 into a non-round, typically elliptical shape. Shaft 801 is used in place of shaft 301 in FIG. 3 and is an example of shaft 101 in FIGS. 1-2.

As can be seen in FIG. 8, lobe ring 806 is a ring with an outer circumference of a circular or roughly circular shape and an inner circumference comprising modified hypotrochoidal lobes. Roll rings 807 are a series of rings positioned within the inner circumference of lobe ring 806 and that engage with the inner circumference of roll rings 807. Pin structure 808 comprises a plate with a series of pins, where each pin is placed within a roll ring 807. Outer race 810 is a flexible ring which can continuously deform to accommodate a maximum radius that occurs when roll rings 807 on opposing sides of the elliptical bearing 809 (e.g., roll rings 807 at the top and bottom of FIG. 8) are both sitting in the valley of the lobes within lobe ring 806, at their furthest from the center axis of shaft 801. Outer race 810 engages with roll rings 807. In this example, the lobes in lobe ring 806 have a modified hypotrochoidal shape, but other shapes such as other Roulette shapes can be used instead.

In one example, pin structure 808 rotates and lobe ring 806 is fixed to the housing (not shown) and does not rotate, and pin structure 808 is fixed to the output shaft (not shown) such that when pin structure 808 rotates around the axis of shaft 801, it turns the output shaft around the axis. In another example, lobe ring 806 rotates and pin structure 808 is fixed to the housing (not shown) and does not rotate, and lobe ring 806 is fixed to the output shaft (not shown) such that when lobe ring 806 rotates around the axis of shaft, it turns the output shaft around the axis.

Optionally, gear structure 805 can comprise a retainer (not shown, such as retainer 1013 in FIG. 10) for retaining rolling elements 812 in their relative position as to one another, to prevent jamming. Optionally, gear structure 805 can comprise a retainer (not shown, such as retainers 1201 and 1401) for retaining roll rings 807 in their relative position as to one another.

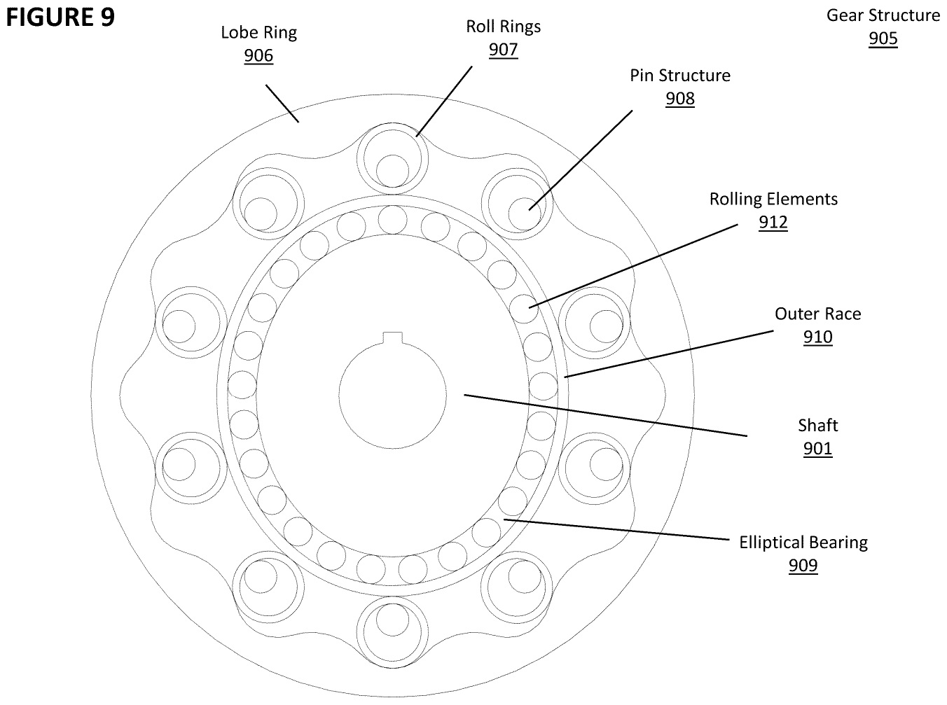

FIG. 9 depicts gear structure 905, which is a third embodiment of a gear structure and which can be used in place of gear structure 305 in torque multiplier 300 in FIG. 3. FIG. 9 depicts an embodiment with a flexible eccentric bearing race. Gear structure 905 comprises lobe ring 906, roll rings 907, pin structure 908, and bearing 909. Bearing 909 comprises outer race 910 and rolling elements 912. In this example, shaft 901 is integrated with an elliptical inner race, and outer race 910 is a flexible race, such that its radius will move in relation to the axis of shaft 901, following the contour of the elliptical race on shaft 901, and supported by rolling elements 912. Shaft 901 is used in place of shaft 301 in FIG. 3 and is an example of shaft 101 in FIGS. 1-2. As used herein, the term “elliptical” refers to true elliptical shapes as well as offset ellipse shapes and modified ellipse shapes.

As can be seen in FIG. 9, lobe ring 906 is a ring with an outer circumference of a circular or roughly circular shape and an inner circumference comprising modified hypotrochoidal lobes. Roll rings 907 are a series of rings positioned within the inner circumference of lobe ring 906 and that engage with the inner circumference of roll rings 907. Pin structure 908 comprises a plate with a series of pins, where each pin is placed within a roll ring 907. Bearing 909 is elliptical because its outerradius moves in relation to the axis of shaft 301 due to the way in which roll rings 907 interact with the peaks and valleys of the inner circumference of lobe ring 906. Outer race 910 engages with roll rings 907. In this example, the lobes in lobe ring 906 have a modified hypotrochoidal shape, but other shapes such as other Roulette shapes can be used instead.

In one example, pin structure 908 rotates and lobe ring 906 is fixed to the housing (not shown) and does not rotate, and pin structure 908 is fixed to the output shaft (not shown) such that when pin structure 908 rotates around the axis of shaft 901, it turns the output shaft around the axis. In another example, lobe ring 906 rotates and pin structure 908 is fixed to the housing (not shown) and does not rotate, and lobe ring 906 is fixed to the output shaft (not shown) such that when lobe ring 906 rotates around the axis of shaft, it turns the output shaft around the axis.

Optionally, gear structure 905 can comprise a retainer (not shown, such as retainer 1013 in FIG. 10) for retaining rolling elements 912 in their relative position as to one another, to prevent jamming. Optionally, gear structure can comprise a retainer (not shown, such as retainers 1201 and 1401) for retaining roll rings 907 in their relative position as to one another.

FIG. 10 depicts gear structure 1005, which is a fourth embodiment of a gear structure and which can be used in place of gear structure 305 in torque multiplier 300 in FIG. 3. FIG. 10 shows the relative motion of key components in a traction planetary eccentric drive type implementation designed to provide an further torque multiplication factor of approximately 2. Gear structure 1005 comprises lobe ring 1006, roll rings 1007, pin structure 1008, and bearing 1009. Bearing 1009 comprises outer race 1010 and rolling elements 1012 and retainer 1013. Rolling elements 1012 do not all have the same diameter. That is, rolling elements 1012 comprise rolling elements of two or more diameters. In this example, shaft 1001 is concentric and not eccentric, and outer race 1010 is a circular race but because the rolling elements 1012 are of different diameters, the motion of outer race 1010 will be eccentric such that its axis will move in relation to the axis of shaft 1001. Retainer 1013 keeps the rolling elements 1012 in position relative to one another and prevents jamming of rolling elements 1012 that might occur in its absence. Shaft 1001 is used in place of shaft 301 in FIG. 3 and is an example of shaft 101 in FIGS. 1-2.

As can be seen in FIG. 10, lobe ring 1006 is a ring with an outer circumference of a circular shape and an inner circumference comprising modified hypotrochoidal lobes. Roll rings 1007 are a series of rings positioned within the inner circumference of lobe ring 1006 and that engage with the inner circumference of roll rings 1007. Pin structure 1008 comprises a plate with a series of pins, where each pin is placed within a roll ring 1007. Outer race 1010 engages with roll rings 1007. In this example, the lobes in lobe ring 1006 have a modified hypotrochoidal shape, but other shapes such as other Roulette shapes can be used instead.

In one example, pin structure 1008 rotates and lobe ring 1006 is fixed to the housing (not shown) and does not rotate, and pin structure 1008 is fixed to the output shaft (not shown) such that when pin structure 1008 rotates around the axis of shaft 1001, it turns the output shaft around the axis. In another example, lobe ring 1006 rotates and pin structure 1008 is fixed to the housing (not shown) and does not rotate, and lobe ring 1006 is fixed to the output shaft (not shown) such that when lobe ring 1006 rotates around the axis of shaft, it turns the output shaft around the axis.

Optionally, gear structure can comprise a retainer (not shown, such as retainers 1201 and 1401) for retaining roll rings 1007 in their relative position as to one another.

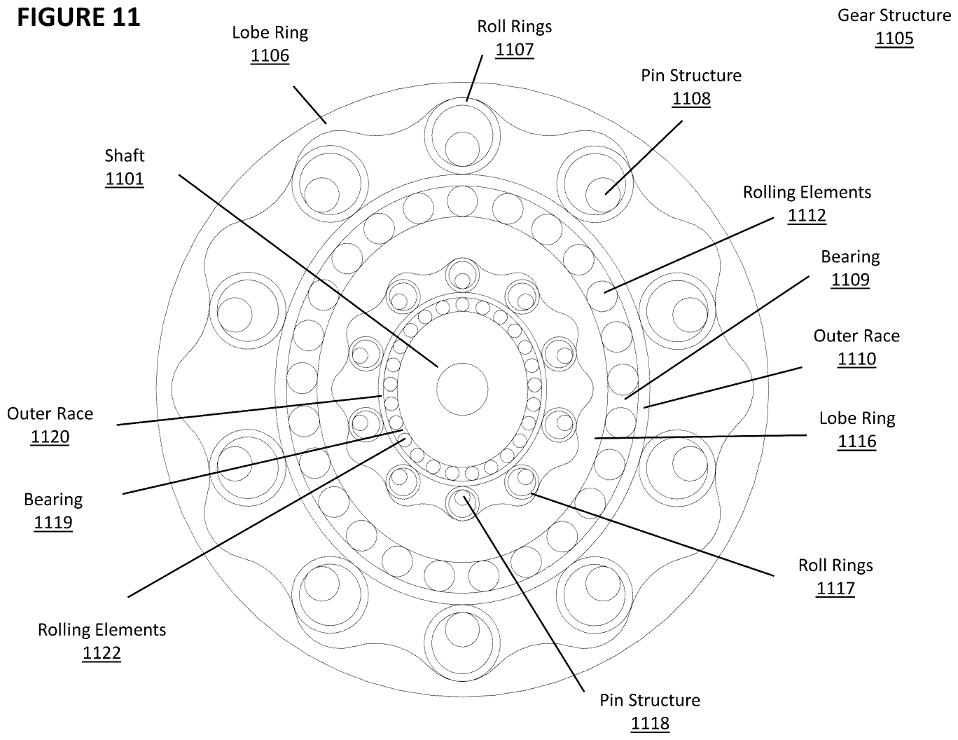

FIG. 11 depicts gear structure 1105, which is a fifth embodiment of a gear structure and which can be used in place of gear structure 305 in torque multiplier 300 in FIG. 3. FIG. 11 depicts a view of a compound arrangement with two nested 6:1 strain wave stages in series for a total 36:1 ratio, calculated for uses where the lobe ring 1106 attached to the low speed shaft and shaft 1101 is the high speed shaft Gear structure 1105 contains two stages each containing a flexible eccentric bearing race. Gear structure 1105 comprises lobe ring 1106, roll rings 1107, pin structure 1108, bearing 1109 (which comprises outer race 1110 and rolling elements 1112), lobe ring 1116, roll rings 1117, pin structure 1118, and bearing 1119 (which comprises outer race 1120 and rolling elements 1122). Also shown is shaft 1101 that engages with gear structure 1105. Shaft 1101 is used in place of shaft 301 in FIG. 3 and is an example of shaft 101 in FIGS. 1-2.

As can be seen in FIG. 11, lobe ring 1106 is a ring with an outer circumference of a circular or roughly circular shape and an inner circumference comprising modified hypotrochoidal lobes. Roll rings 1107 are a series of rings positioned within the inner circumference of lobe ring 1106 and that engage with the outer circumference of outer race 1110 and pin structure 1108. Pin structure 1108 comprises a plate with a series of pins, where each pin is placed within a roll ring 1107. Bearing 1109 is elliptical because the inner race integrated into lobe ring 1116 is elliptical. Outer race 1110 engages with roll rings 1107. In this example, the lobes in lobe ring 1106 have a modified hypotrochoidal shape, but other shapes such as other Roulette shapes can be used instead.

Lobe ring 1116 is a ring with an outer circumference of an ellipitcal or roughly elliptical shape and an inner circumference comprising modified hypotrochoidal lobes. Roll rings 1117 are a series of rings positioned within the inner circumference of lobe ring 1116 and that engage with the inner circumference of lobe ring 1116. Pin structure 1118 comprises a plate with a series of pins, where each pin is placed within a roll ring 1117. Bearing 1119 is elliptical because shaft 1101 has an integrated elliptical inner race. Outer race 1120 engages with roll rings 1117.

In one example, pin structure 1108 and pin structure 1118 are fixed together and rotates whilelobe ring 1106 is fixed to the housing (not shown) and does not rotate, and pin structure 1108 is fixed to the output shaft (not shown) such that when pin structure 1108 rotates around the axis of shaft 1101, it turns the output shaft around the axis. In another example, lobe ring 1106 rotates and pin structure 1108 and pin structure 1118 are fixed to the housing (not shown) and do not rotate, and lobe ring 1106 is fixed to the output shaft (not shown) such that when lobe ring 1106 rotates around the axis of shaft, it turns the output shaft around the axis.

Optionally, gear structure 1105 can comprise a retainer (not shown, such as retainer 1013 in FIG. 10) for retaining rolling elements 1112 in their relative position as to one another and a retainer (not shown, such as retainer 1013 in FIG. 10) for retaining rolling elements 1122 in their relative position as to one another, to prevent jamming. Optionally, gear structure 1105 can comprise a retainer (not shown, such as retainers 1201 and 1401) for retaining roll rings 1107 in their relative position as to one another and a retainer (not shown, such as retainers 1201 and 1401) for retaining roll rings 1117 in their relative position as to one another.

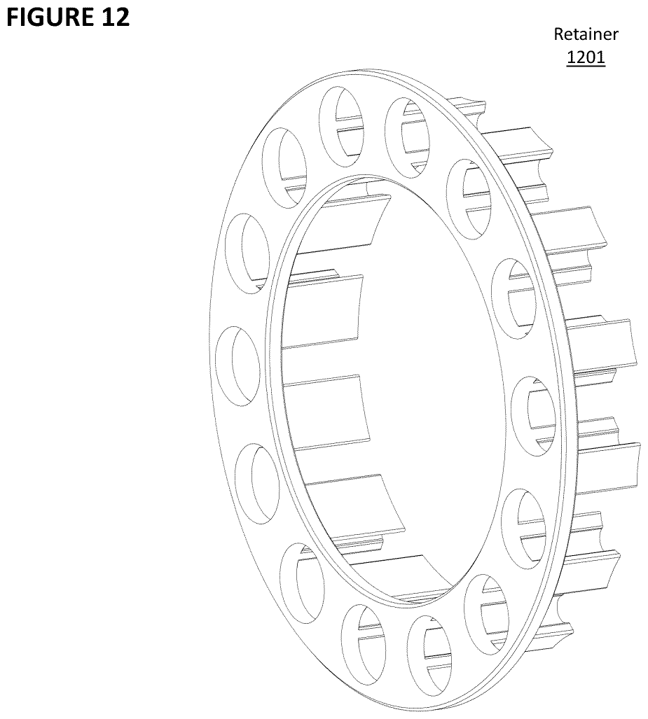

FIG. 12 depicts a perspective view of retainer 1201, which has a single-piece design.

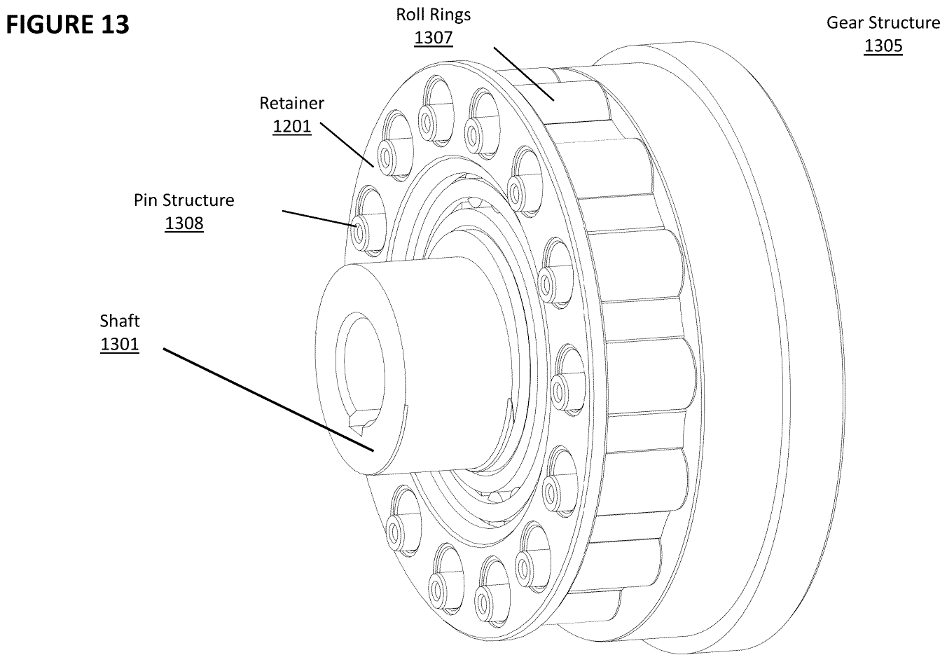

FIG. 13 depicts gear structure 1305, which is a sixth embodiment of a gear structure and which can be used in place of gear structure 305 in torque multiplier 300 in FIG. 3. FIG. 13 depicts a perspective view of a one-piece retainer in position with various components removed for clarity. Gear structure 1305 comprises retainer 1201, roll rings 1307, and pin structure 1308. Gear structure 1305 engages with shaft 1301. Each of the roll rings 1307 is placed with an opening in retainer 1201. During operation, retainer 1201 retains the position of roll rings 1307 with respect to one another, such that the roll rings do not move significantly closer to one another or significantly farther apart from one another. For example, when a roll ring is at the peak of the inner circumference of a lobe ring (not shown) it might move laterally in the absence of retainer 1201.

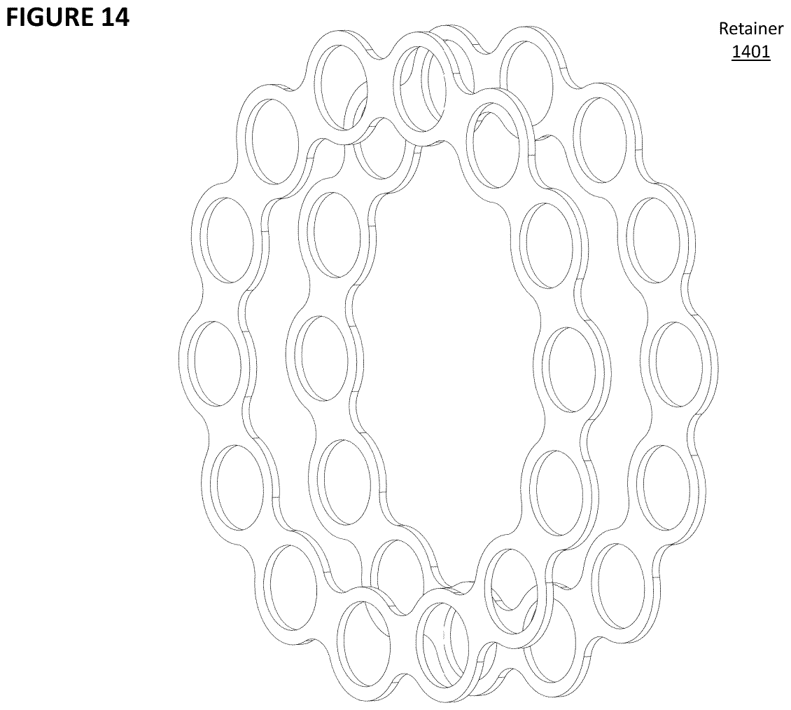

FIG. 14 depicts a perspective view of retainer 1401, which has a two-piece design.

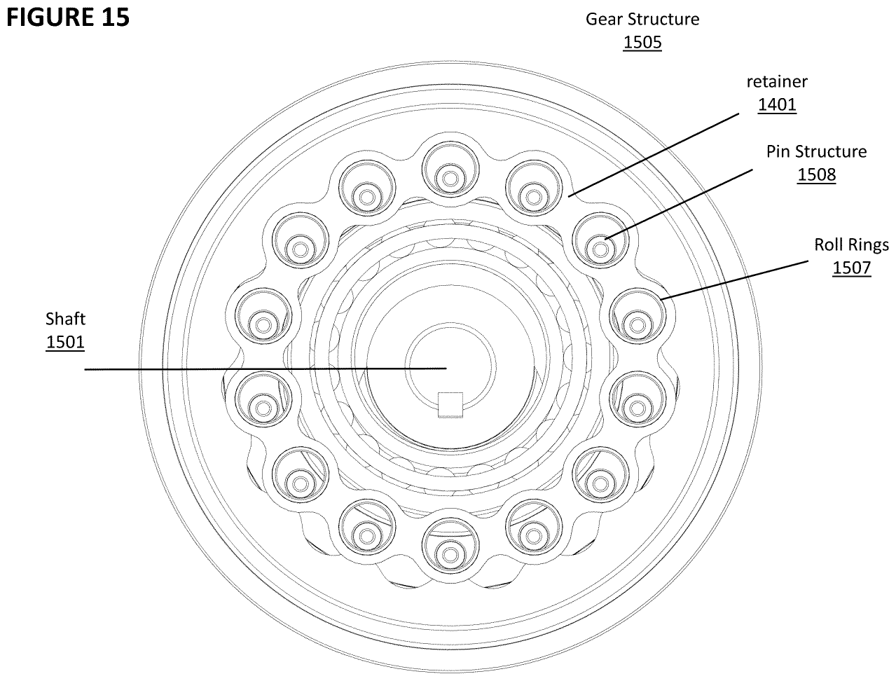

FIG. 15 depicts gear structure 1505, which is a seventh embodiment of a gear structure and which can be used in place of gear structure 305 in torque multiplier 300 in FIG. 3. FIG. 15 depicts an end view of a two-piece retainer in position. Gear structure 1505 comprises retainer 1401, roll rings 1507, and pin structure 1508. Gear structure 1505 engages with shaft 1501. Each of the roll rings 1507 is placed with an opening in retainer 1401. During operation, retainer 1401 retains the position of roll rings 1507 with respect to one another, such that the roll rings do not move significantly closer to one another or significantly farther apart from one another. For example, when a roll ring is at the peak of the inner circumference of a lobe ring (not shown) it might move laterally in the absence of retainer 1401.

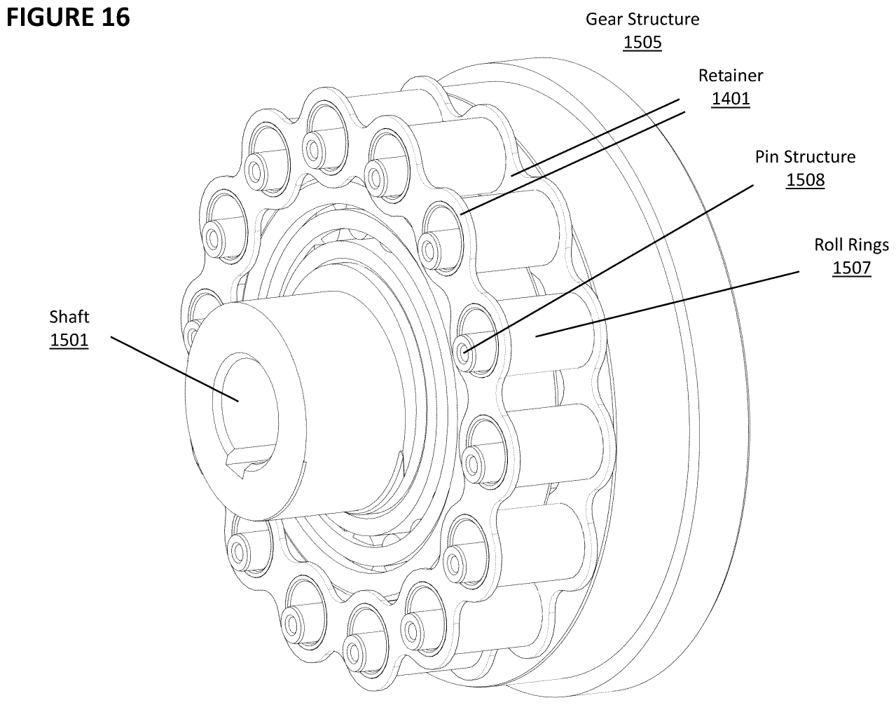

FIG. 16 depicts a perspective view gear structure 1505 with various components removed for clarity and comprising a two-piece retainer. Depicted are retainer 1401, roll rings 1507, pin structure 1508, and shaft 1501.

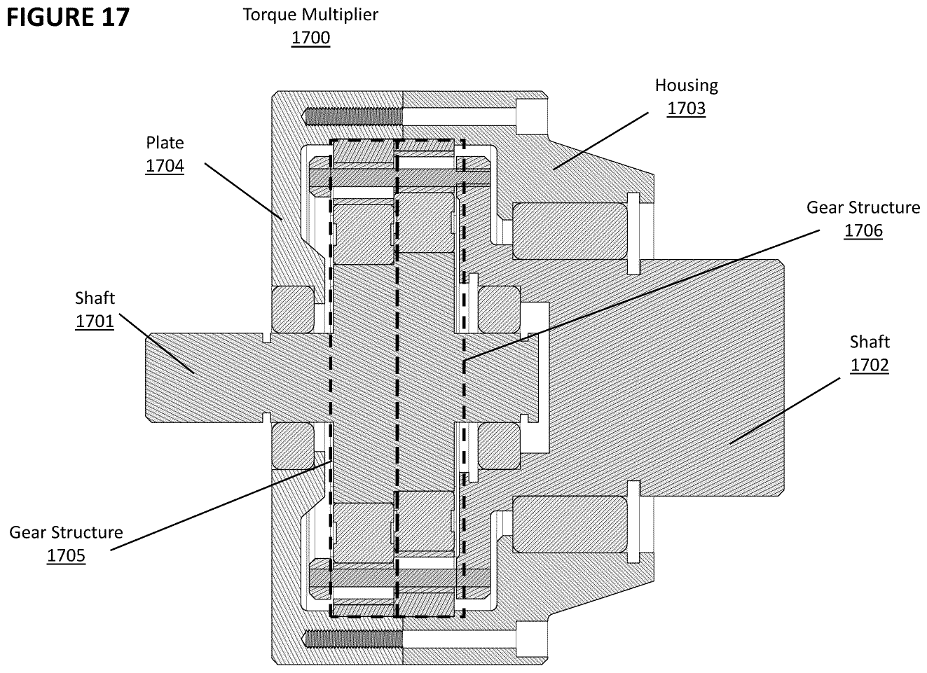

FIG. 17 depicts torque multiplier 1700. Torque multiplier 1700 is an example of torque multiplier 100 using the gear structure depicted in FIG. 17. FIG. 17 depicts a section showing shafts and bearing support of an assembled device with two axially stacked component sets operating kinematically in parallel, offset by 180 degrees. Torque multiplier 1700 comprises shafts 1701 and 1702 (which are examples of shafts 101 and 102 in FIGS. 1-2), housing 1703 (which is an example of housing 103 in FIGS. 1-2), and plate 1704 (which is an example of plate 104 in FIG. 2). Torque multiplier 1700 further comprises gear structure 1705 and gear structure 1706 which are axially stacked and 180 degrees out of phase with one another. In a first mode, shaft 1701 drives gear structure 1705, which in turn drives gear structure 1706, which in turn drives shaft 1702. In a second mode, shaft 1702 drives gear structure 1706, which in turn drives gear structure 1705, which in turn drives shaft 1701. Gear structures 1705 and 1706 can comprise any of gear structures 305, 805, 905, 1005, 1105, 1305, and 1505 described previously. In this example, shaft 1701 is a two-plane crankshaft, and gear structures 1705 and 1706 are 180 degrees out of phase with one another to balance mass about the axis of shaft 1701, and to balance reaction forces across the device. It is possible to extend this stacking concept to three gear structures or four gear structures or more as required by the application.

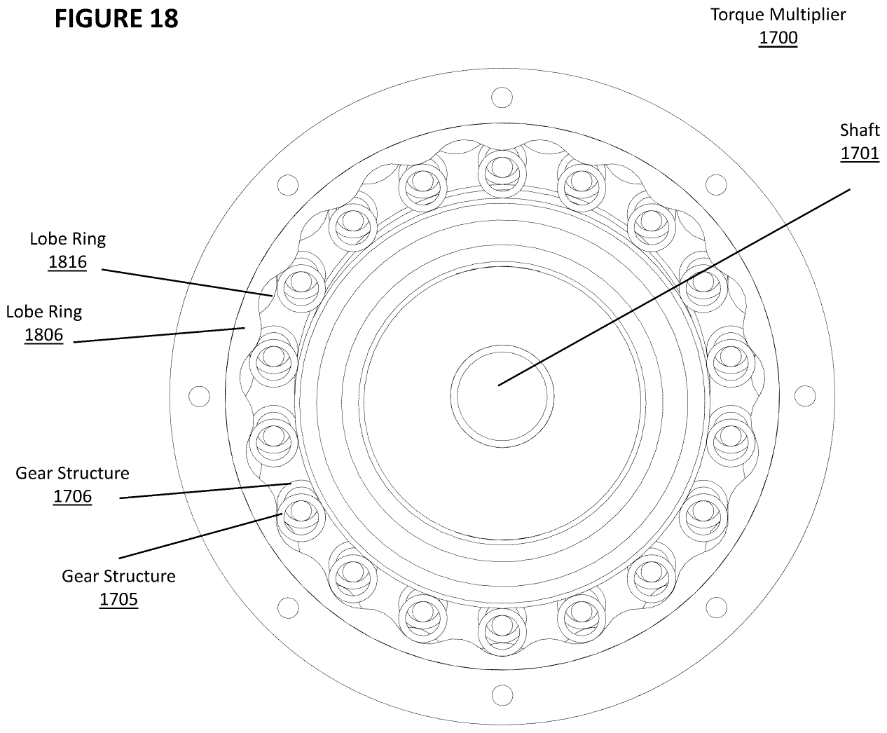

FIG. 18 depicts another perspective of torque multiplier 1700. FIG. 18 shows an end view showing a device with two axially-stacked component sets, offset by 180 degrees, with some components removed for clarity. Shaft 1701 and parts of gear structures 1705 and 1706 are depicted. Gear structure 1705 comprises lobe ring 1806, and gear structure 1706 comprises lobe ring 1816. As can be seen, lobe rings 1806 and 1816 are out of phase with one another.

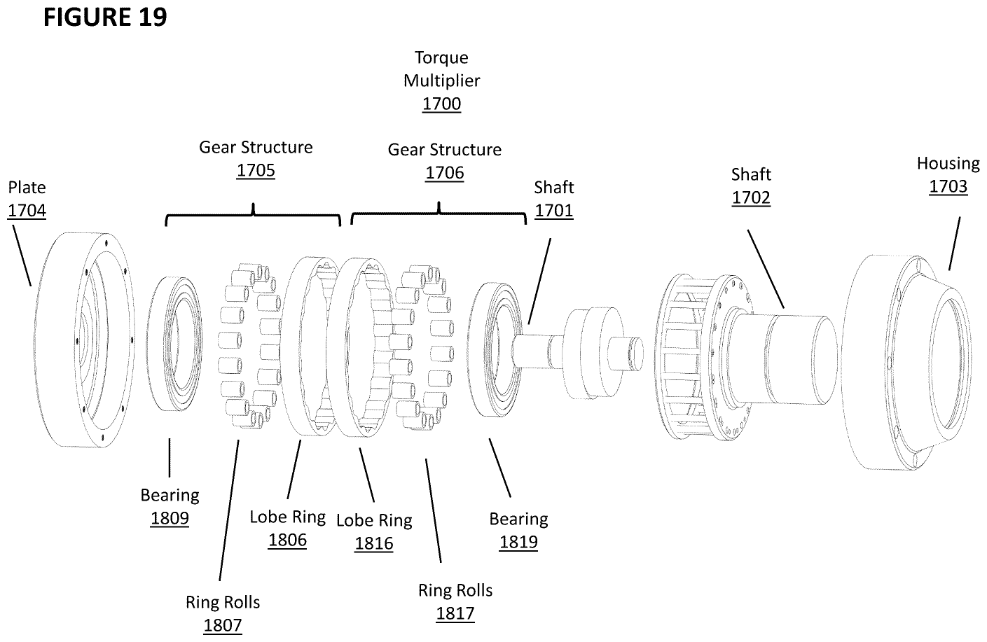

FIG. 19 depicts an exploded view of torque multiplier 1700. FIG. 19 shows a device with two axially stacked component sets, offset by 180 degrees. Torque multiplier 1700 comprises shaft 1701, shaft 1702, housing 1703, plate 1704, gear structure 1705, and gear structure 1706. Gear structure 1705 comprises bearing 1809, roll rings 1807, and lobe ring 1806. Gear structure 1706 comprises bearing 1819, roll rings 1817, and lobe ring 1816. Bearings 1809 and 1819 each comprise rolling elements (not shown) and one or more races in which the rolling elements are placed.

Optionally, gear structures 1705 and 1705 each can comprise a retainer (not shown, such as retainer 1013 in FIG. 10) for retaining rolling elements (not shown) in their relative position as to one another, to prevent jamming. Optionally, gear structures 1705 and 1706 each can comprise a retainer (not shown, such as retainers 1201 and 1401) for retaining roll rings 1807 and 1817, respectively, in their relative position as to one another.

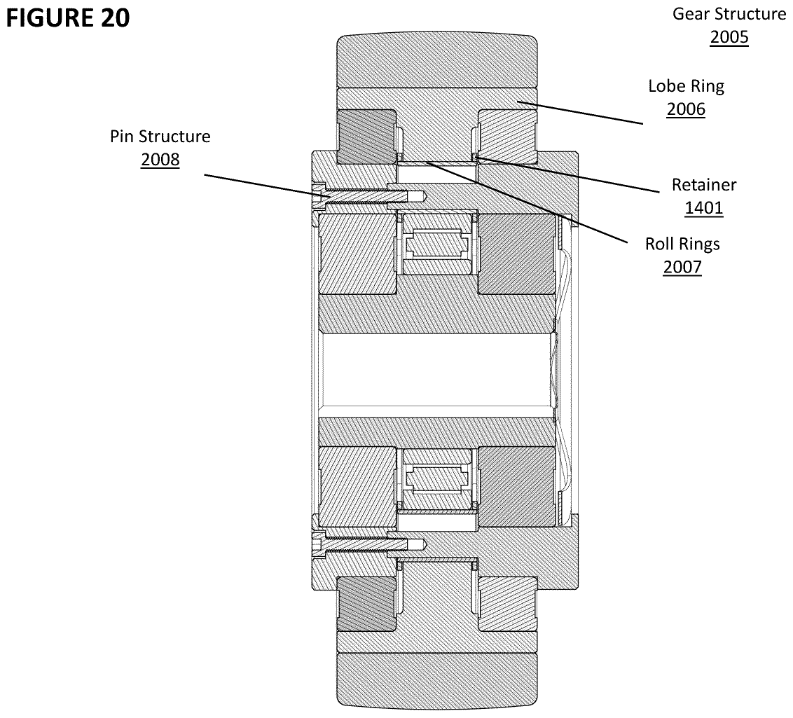

FIG. 20 depicts gear structure 2005, which is an eighth embodiment of a gear structure. FIG. 20 depicts a section view showing a wheel drive application where the lobe ring rotates and the pins are stationary. Gear structure 2005 comprises lobe ring 2006, roll rings 2007, pin structure 2008, and retainer 1401 described previously.

Optionally, gear structure 2005 can comprise a retainer (as shown, and such as retainers 1201 and 1401) for retaining roll rings 2007 in their relative position as to one another.

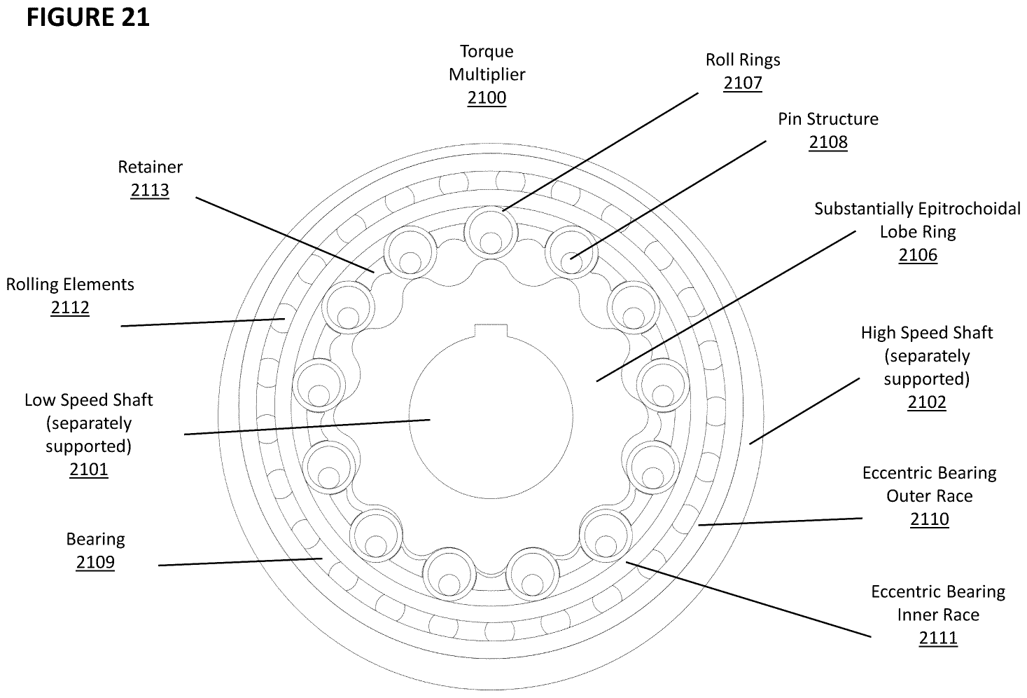

FIG. 21 depicts a torque multiplier with an eighth embodiment of a gear structure. Torque multiplier 2100 is an example of torque multiplier 100 using the gear structure depicted in FIG. 21. FIG. 21 utilizes an eccentric bearing 2109. Torque multiplier 2100 comprises low speed shaft 2101 and high speed shaft 2102 (which are examples of shafts 101 and 102 in FIGS. 1-2), substantially epitrochoidal lobe ring 2106, roll rings 2107, pin structure 2108, and eccentric bearing 2109, and retainer 2113. Bearing 2109 comprises outer race 2110 (which is eccentric), inner race 2111 (which is eccentric), and rolling elements 2112. Retainer 2113 retains roll rings 2107 in their relative position as to one another. Optionally, torque multiplier 2100 can comprise a retainer (not shown, such as retainer 1013 in FIG. 10) for retaining rolling elements 2112 in their relative position as to one another, to prevent jamming.

It should be noted that in certain examples described above, the input shaft is a crank shaft, or an inverted hollow crankshaft as in FIG. 21. A person of ordinary skill in the art will appreciate that alternatively, the output shaft can be a crank shaft and the relationship between the shafts and the components can be inverted compared to those examples. A person of ordinary skill in the art will also appreciate that the gear structures disclosed above can be combined in series or parallel in any number in a torque multiplier to increase the torque multiplication range beyond the stated practical range, or to increase the load capacity as needed.

Additional detail will now be provided as to the operation of the torque multipliers, gear structures, and other components with reference to FIGS. 1-21.

Functional Overview

In a torque multiplier (such as torque multipliers 100, 300, 1700, and 2300), a high speed input shaft (such as shafts 101, 301, 801, 901, 1001, 1101, 1301, 1501, 1701, and 2102) drives an eccentric bearing (such as eccentric bearings 309 and 809) or an elliptical bearing (such as elliptical bearing 909), the outer race of which (such as outer races 310, 810, 910, 1010, and 1110) is in contact with a plurality of rings (such as roll rings 307, 807, 907, 1007, 1107, 1117, 1307, 1507, and 2007), each captive on a pin (such as pin structures 308, 808, 908, 1008, 1108, 1118, 1308, 1508, and 2008) attached to the low-speed output shaft (such as shafts 102, 302, and 1702) or housing (such as housing 103, 303, and 1703). The rings are also in contact with an array of lobes (such as lobe rings 306, 806, 906, 1006, 1106, 1116, 1806, 1816, 2006), attached to the housing (or output shaft). The number of rings and pins is equal, but the number of lobes differs with the number of rings by at least one, typically one for an eccentric bearing or two for an elliptical bearing, but three and more are possible. Instead of an eccentric bearing or elliptical bearing other non-circular shapes can be used for bearings, such as a tri-lobe bearing.

The nature of the contact between the components described reduces the relative sliding velocity at each contact, passing through a point of simultaneous pure rolling at the lobe-ring and ring-pin interfaces. If the eccentric bearing is allowed to rotate freely it will also tend to reduce the average sliding velocity between the outer race and the rings. This point of no sliding can be designed to coincide with the point of highest force, greatly reducing the system friction.

A basic eccentric bearing implementation may be imbalanced due to the mass of the parts moving with the eccentric axis, in these cases it can be advantageous to balance the system either by adding a counterweight, or by utilizing two axially stacked sets of component sets (as discussed in greater detail below), with the eccentric position offset by 180 degrees to cancel radial imbalance. Stacks of two, three or four component sets can be used to further balance the forces and inertia of the system.

The system may be divided into 3 major functional sets: the high speed eccentric shaft/wave generator, the pin structure anti-rotation mechanism, and the lobe ring.

High Speed Eccentric Shaft/Wave Generator

The eccentric motion of the roll-rings can be generated in several ways. The simplest is by the use of a crankshaft (such as shafts 301 and 1701) with an eccentric bearing to drive the roll-ring motion directly. Another implementation uses a deformed roller bearing assembly (such as bearings 309, 809, and 909) to create two or more eccentric periods per high speed shaft rotation. In an alternate configuration, the eccentric motion can be created by an array of rolling elements of varying size (such as rolling elements 1012), creating one, two or more eccentric periods per rotation of the rolling element set. This implementation creates a two stage reduction, where the first stage is effectively a traction based planetary eccentric drive, and the second stage is the roll-ring, pin and lobe system. The traction first stage can either drive a circular bearing race on an eccentric axis, or a flexible ellipse-like two lobe bearing, or similar shapes with three or more lobes. This implementation provides an additional drive ratio change compared to implementations where the first stage is a regular crankshaft and bearing, at very little cost to efficiency, mass or volume.

In the traction planetary implementation (such as gear structures 805 and 1005), the high speed shaft is a cylindrical roller in the center of the device, which acts as a ‘sun’ roller in contact with a plurality of rollers. These ‘planet’ rollers are also in contact with an outer race, which acts as the annular ring in a planetary system. The planet rollers are varied in size to allow the annular ring and orbiting disc to orbit in an eccentric path without losing contact. This first stage of the mechanism offers an initial speed reduction of between 2.1:1 and 14:1 depending on the size of the sun and annulus. A typical ratio for this first stage would be 3:1.

The eccentric traction planetary system described above is one convenient way to generate the eccentric motion of the orbiting plate, as it increases the range of possible multiplication ratios without significantly increasing the system inertia or complexity. The disadvantage of traction based systems is that the exact torque ratio may vary in operation due to small amounts of slip that occur. In some applications this is problematic.

Anti-Rotation Mechanism

The array of roll-rings must be prevented from rotating in relation to the low-speed output or fixed reference frame, whilst still allowing for the circular motion caused by the crankshaft motion. The disclosed invention features a unique pure-rolling anti-rotation device (such as pin structures 308, 808, 908, 1008, 1108, 1118, 1308, 1508, and 2008).

The anti-rotation mechanism works with an array of fixed pins, each of a diameter less than the internal diameter of the roll-rings by approximately the diameter of the crankshaft eccentricity or the amplitude of the ellipse-like flexible bearing race. An array of these pins and rings, when sequentially loaded by the eccentric bearing motion will cause torque to be generated between the pins and the lobe ring.

Traditional implementations use an array of fixed pins and a matching array of holes in an orbiting cycloid disc to prevent rotation. Undesirable friction is caused by the contact between the pins and the cycloid disc and often requires additional measures to be taken to reduce friction. These traditional implementations are often the source of significant frictional losses and can cause non-linear torque ripples.

The disclosed mechanism is advantageous due to its simplicity, low manufacturing cost, high torque capacity, compact form factor and reduced frictional losses. The near-pure rolling motion also allows very smooth and linear torque output compared to traditional anti-rotation mechanisms.

Lobe Ring

In the described implementation, the lobe ring (such as lobe rings 306, 806, 906, 1006, 1106, 1116, 1806, 1816, 2006) features a number of similar lobes, based on a trochoidal curve. In a typical configuration, the orbiting plate has a number between 4 and 400 lobes. In the implementations shown, the number of lobes is one or two more or less than the number of roll-rings, and each roll-ring has a torque pin. This rule can be varied, but it is typically not advantageous to do so. In order for the device to function it is essential that the number of lobes and roll-rings are different by at least one.

A trochoid based curve is advantageous over other curve forms because the roll-rings can maintain their respective spacing and relative positions, which means they can be supported by a simple rigid retainer. The trochoid curve parameters are chosen in such a way as to achieve near-pure rolling motion between the various components to maximize the efficiency and torque transfer ability. (These values can be optimized for different variables based on the requirements of the application).

An offset pure trochoid profile is functional, however the lobe profile may be strategically modified to allow running clearance for lubrication, increased manufacturing ease, reduced loading in sliding zones, to control lash or to reduce loading end-effects. An alternate configuration can invert the structure, putting the roll-rings outside of the lobe ring, in which case the lobes will become substantially epitrochoidal rather than hypotrochoidal, however the same principles apply. Other Roulette shapes can be used instead for the lobes. It is also possible to use non-trochoidal lobe profiles to reduce rolling friction, increase load capacity or improve manufacturability.

Retainer

In some implementations it is preferable to control the position of the roll-rings in relation to one another and to the eccentric axis. A simple retainer (such as retainers 1201 and 1401) can be used to prevent the roll-rings moving from their desired position during operation.

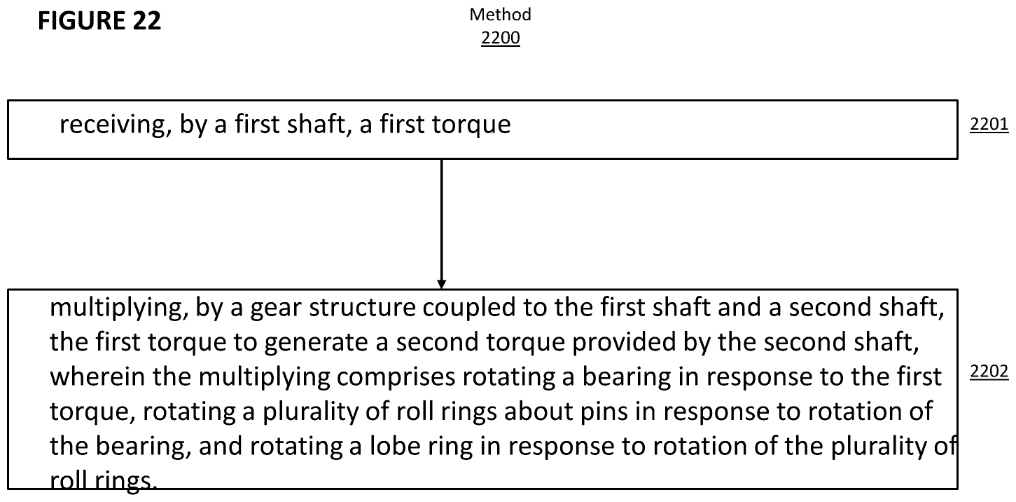

FIG. 22 depicts method 2200, which is a method of operating torque multipliers 100, 300, 1700, or 2300 using any of the embodiments described above. Step 2201 comprises receiving, by a first shaft, a first torque. Step 2102 comprises multiplying, by a gear structure coupled to the first shaft and a second shaft, the first torque to generate a second torque provided by the second shaft, wherein the multiplying comprises rotating a bearing in response to the first torque, rotating a plurality of roll rings about pins in response to rotation of the bearing, and rotating a lobe ring in response to rotation of the plurality of roll rings. Optionally, the multiplying of step 2202 further comprises preventing movement of the roll rings by a pin structure, or the multiplying of step 2202 further comprises rotating a pin structure comprising pins located in the plurality of roll rings and wherein the pin structure is fixed to the second shaft to rotate the second shaft to provide the second torque.

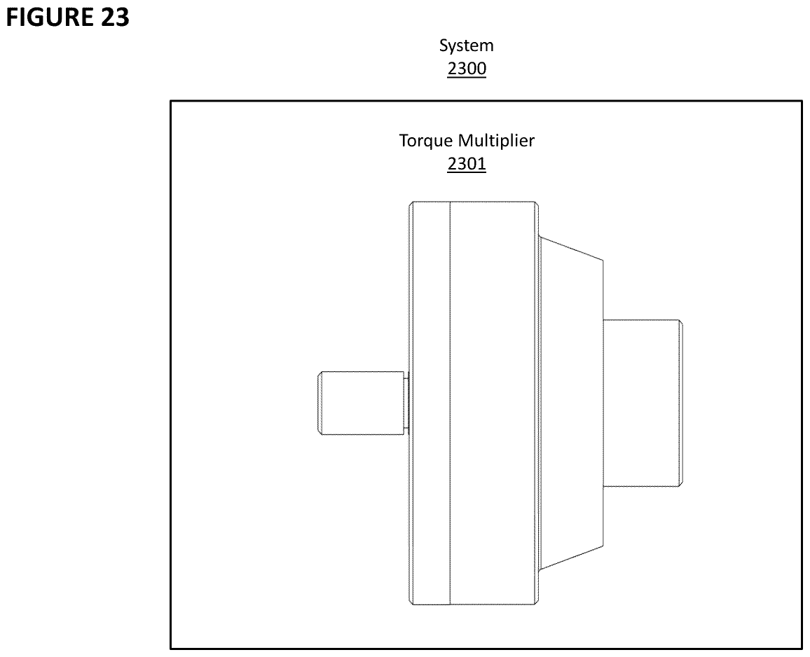

FIG. 23 depicts system 2300 that comprises and utilizes torque multiplier 2301, where torque multiplier 2301 can be any torque multiplier described above, such as torque multipliers 100, 300, 1700, and 2300. System 2300 can be any system that requires a torque multiplier to increase or decrease torque between an input shaft and an output shaft. System 2300 can be any of the following examples:
Aerospace and Defense (CPC classifications B64C, B64D, B64G, F41G), including but not limited to:
   Main propulsion gearboxes for aircraft
   Tail rotor drives for helicopters
   Actuators for unmanned aerial vehicle (UAV) propulsion systems
   Drivetrains for defense armored vehicles
   Actuators for aircraft control surfaces
   Satellite solar panel drives
   Gear systems for space exploration rovers
   Drilling and manipulation mechanisms for space applications
Automotive and Transportation (CPC classifications B60K, B60W, B62D), including but not limited to:
   Transmission systems for electric and hybrid electric vehicles
   Gearboxes for turbocharger and supercharger hybrid systems for combustion engines
   Actuators for power steering systems
   Drivetrains for eBikes and personal mobility devices
Marine and Offshore Technology (CPC classifications B63B, B6311, E21B), including but not limited to:
   Propulsion gearboxes for ships
   Drive systems for marine actuators
   Gear reducers for offshore drilling equipment
Construction and Heavy Machinery (CPC classifications E02F, B66C, E21C), including but not limited to:
   Drive systems for excavators and bulldozers
   Gearboxes for concrete pump trucks
   Rotary systems for tunnel boring machines
   Electrification of boom and jib actuators in earthmoving equipment
Agriculture and Forestry (CPC classifications A01B, A01D, A01G), including but not limited to:
   Reduction gearing for tractors
   Drivetrains for combine harvesters
   Actuators for irrigation systems
   Drivetrains for forestry equipment
Energy and Power Generation (CPC classifications F03D, Y02E, H02S), including but not limited to:
   Gearboxes for wind turbines
   Drives for hydroelectric generator speed control
   Actuators for solar tracking systems
Industrial and Manufacturing Automation (CPC classifications B25J, B23Q, H01L), including but not limited to:
   Actuators for conveyor belt systems
   Gearboxes for robotic arms and manipulators
   Drive systems for automated guided vehicles (AGVs)
   Actuators for CNC and semiconductor manufacturing equipment
Consumer Goods and Appliances (CPC classifications A47L, B25F, A63H), including but not limited to:
   Drivetrains for automated home appliances
   Gear systems for power tools
   Actuators for toys and electronic gaming devices
Medical Devices and Healthcare (CPC classifications A61B, A61F, A61H), including but not limited to:
   Gear systems for surgical and diagnostic tools
   Drive mechanisms for medical equipment
   Actuation systems for advanced prosthetics
Entertainment and Fitness (CPC classifications A63G, A63B, H05B), including but not limited to:
   Drive systems for theme park rides
   Mechanisms for movie special effects
   Drivetrains for exercise and sports training equipment
Logistics and Material Handling (CPC classifications B65G, B66F, B25J), including but not limited to:
   Drivetrains for warehouse robotics
   Actuators for sorting systems and palletizers
   Gearboxes for forklifts and logistics vehicles
Public Infrastructure and Safety (CPC classifications E04H, A62B, B66B), including but not limited to:
   Gearboxes for elevators and escalators
   Winch systems for emergency rescue
   Actuators for firefighting and rescue robotics
   Radar positioning drives (CPC classifications G01S, G01C)
Science and Exploration (CPC classifications G01N, G01J, B64G), including but not limited to:
   Drives for laboratory centrifuges
   Actuation systems for telescopes and astronomical instruments

Materials

The gearing mechanisms disclosed herein are designed with versatility in mind, accommodating a range of materials to meet the specific requirements of the application, including but not limited to: high-strength alloys, stainless steel for corrosion resistance, titanium for its strength-to-weight ratio and low modulus, aluminum for lightweight applications, brass for its machinability, thermoplastics for quiet operation, composites for tailored thermal and structural properties, and advanced ceramics for high-wear environments. The selection of material aims to optimize the performance, durability, and efficiency of the gears in their respective applications, whether it be for high load-bearing capabilities, precision operation, or environmental resilience. Additionally, the use of cutting-edge materials such as metal matrix composites and self-lubricating polymers is anticipated to adapt to future advancements in material science, thus ensuring the gearing mechanisms remain at the forefront of technological progress in power transmission.

Key Improvements

The disclosed improvements listed below each contribute to the energy efficiency & performance of the torque multiplication device:
Rolling contact between roll-ring and lobes profile optimization (reduction of sliding friction at lobes).
Rolling contact low friction anti-rotation mechanism (elimination of sliding friction on output pins).
Combined eccentric bearing and planetary reducer (increased torque ratio without significantly increased friction or complexity).
The near-pure rolling contacts in the lobe-ring-pin interfaces combined with the compliance of the rings allow for lash to be significantly reduced or eliminated completely by preloading the interfaces. This is impractical in traditional torque multipliers because the resulting friction would be too high.

Advantages Over Existing Devices

Advantages of the embodiments described herein over prior art devices include the following:
Reduced cost and manufacturing complexity.
Relatively high efficiency, in the range of 70% to 100% power transfer efficiency. Large hollow bore can facilitate cable routing and design packaging.
High torque density due to load sharing between lobes.
Smooth and quiet operation due to the rolling contact and optimized geometry, allowing continuous contact between roll-rings, pins and lobes.
Reduced system inertia.
The ratio of speed reduction or torque multiplication is one of the defining characteristics of the device. This application applies to devices typically in the ratio ranges of 7:1 to 400:1, although gear structures can be combined in series in the same housing to produce torque ratios several orders of magnitude higher or lower

1. A torque multiplier, comprising:
a first shaft for providing a first torque;
a second shaft for providing a second torque; and
a gear structure coupled to the first shaft and the second shaft to multiply the first torque to generate the second torque, the gear structure comprising:
a lobe ring;
a plurality of roll rings in contact with the lobe ring;
a pin structure comprising a plurality of pins, each of the pins located inside one of the roll rings; and
a bearing in contact with the plurality of roll rings.

2. The torque multiplier of claim 1, wherein the bearing is eccentric.

3. The torque multiplier of claim 1, wherein the bearing is elliptical.

4. The torque multiplier of claim 1, wherein the bearing further comprises a first race in contact with the plurality of roll rings.

5. The torque multiplier of claim 4, wherein the bearing further comprises a second race and a plurality of rolling elements between the first race and the second race.

6. The torque multiplier of claim 1, wherein the lobe ring comprises an inner circumference comprising modified hypotrochoidal lobes.

7. The torque multiplier of claim 1, further comprising a retainer for holding the plurality of roll rings.

8. The torque multiplier of claim 7, wherein the retainer is a single piece.

9. The torque multiplier of claim 7, wherein the retainer is a double piece.

10. A torque multiplier, comprising:
a first shaft for providing a first torque;
a second shaft for providing a second torque;
a first gear structure coupled to the first shaft to receive the first torque, the first gear structure comprising:
a first lobe ring;
a first plurality of roll rings in contact with the first lobe ring;
a first pin structure comprising a plurality of pins, each of the pins located inside one of the roll rings in the first plurality of roll rings; and
a first bearing in contact with the plurality of roll rings; and
a second gear structure coupled to the first gear structure and the second shaft to multiply the first torque to generate the second torque, the second gear structure comprising:
a second lobe ring;
a second plurality of roll rings in contact with the second lobe ring;
a second pin structure comprising a plurality of pins, each of the pins located inside one of the roll rings in the second plurality of roll rings; and
a second bearing in contact with the plurality of roll rings.

11. The torque multiplier of claim 10, wherein the first lobe ring comprises an inner circumference comprising modified hypotrochoidal lobes.

12. The torque multiplier of claim 11, wherein the second lobe ring comprises an inner circumference comprising modified hypotrochoidal lobes.

13. A method of multiplying torque, comprising:
receiving, by a first shaft, a first torque; and
multiplying, by a gear structure coupled to the first shaft and a second shaft, the first torque to generate a second torque provided by the second shaft, wherein the multiplying comprises rotating a bearing in response to the first torque, rotating a plurality of roll rings about pins in response to rotation of the bearing, and rotating a lobe ring in response to rotation of the plurality of roll rings.

14. The method of claim 13, wherein the lobe ring is fixed to the second shaft to rotate the second shaft to provide the second torque.

15. The method of claim 14, wherein the multiplying further comprises preventing movement of the roll rings by a pin structure.

16. The method of claim 14, wherein the multiplying further comprises rotating a pin structure comprising pins located in the plurality of roll rings and wherein the pin structure is fixed to the second shaft to rotate the second shaft to provide the second torque.

17. The method of claim 13, wherein the bearing is eccentric.

18. The method of claim 13, wherein the bearing is elliptical.

19. The method of claim 13, wherein the bearing comprises a first race in contact with the plurality of roll rings.

20. The method of claim 19, wherein the bearing further comprises a second race and a plurality of rolling elements between the first race and the second race.

21. The method of claim 20, wherein the lobe ring comprises an inner circumference comprising modified hypotrochoidal lobes.
